(19) United States
(12) Patent Application Publication
(10) Pub. No.: US 2025/0079677 A1
(43) Pub. Date: Mar. 6, 2025

(54) Transmission Line, Transmission Cable, Transmission Line Preparation Method, and Electronic Device

(71) Applicant: Huawei Technologies Co., Ltd., Shenzhen (CN)

(72) Inventors: Xiongbin Yu, Shenzhen (CN); Teyan Chen, Shenzhen (CN); Yixin Wu, Shenzhen (CN)

(21) Appl. No.: 18/951,808

(22) Filed: Nov. 19, 2024

Related U.S. Application Data
(63) Continuation of application No. PCT/CN2023/093625, filed on May 11, 2023.

(30) Foreign Application Priority Data
May 19, 2022 (CN) 202210555053.4

(51) Int. Cl. H01P 3/06; H01P 11/00

(52) U.S. Cl. CPC H01P 3/06; H01P 11/001

(57) ABSTRACT

A transmission line includes an outer housing, an outer conductor, a support plate, and an inner conductor. The outer housing may include a first housing and a second housing that are fastened to each other. The first housing has a first groove, the second housing has a second groove, and the first groove and the second groove are enclosed to form a path. The outer conductor may include a first conducting layer and a second conducting layer. The first conducting layer is located on an inner wall of the first groove, and the second conducting layer is located on an inner wall of the second groove. The support plate is suspended in the path, and at least a part of an edge of the support plate is fastened between the first housing and the second housing.

### CROSS-REFERENCE TO RELATED APPLICATIONS

This is a continuation of Int'l Patent App. No. PCT/CN2023/093625, filed on May 11, 2023, which claims priority to Chinese Patent App. No. 202210555053.4, filed on May 19, 2022, both of which are incorporated by reference.

### TECHNICAL FIELD

This disclosure relates to the field of communication technologies, and in particular, to a transmission line, a transmission cable, a transmission line preparation method, and an electronic device.

### BACKGROUND

A transmission line is a linear structure for transmitting an electromagnetic wave, and is widely used in various types of integrated circuits to connect various passive components and active components. With the rapid progress of science and technology and huge market demand, a radio-frequency integrated circuit is developing into diversification, integration and high frequency band. A metal rectangular waveguide has advantages of a low transmission loss, a large power capacity, and the like when being used as a transmission line, but the metal rectangular waveguide has many problems such as difficult mechanical processing, a large size, and a large weight. Therefore, how to provide a transmission line that is easy to manufacture and facilitates miniaturization and lightening design is an urgent technical problem to be resolved.

### SUMMARY

This disclosure provides a transmission line that is easy to manufacture and facilitates miniaturization and lightening design, a transmission cable, a transmission line preparation method, and an electronic device.

According to a first aspect, this disclosure provides a transmission line. The transmission line may include an outer housing, an outer conductor, a support plate, and an inner conductor. Specifically, the outer housing may include a first housing and a second housing that are fastened to each other. The first housing has a first groove, the second housing has a second groove, and the first groove and the second groove are enclosed to form a path. The outer conductor may include a first conducting layer and a second conducting layer. The first conducting layer is located on an inner wall of the first groove, and the second conducting layer is located on an inner wall of the second groove. The support plate is suspended in the path, and at least a part of an edge of the support plate is fastened between the first housing and the second housing. The inner conductor is disposed on at least one plate surface of the support plate.

In the transmission line provided in this disclosure, the outer housing of the transmission line includes the first housing and the second housing. Therefore, during manufacturing, the first housing and the second housing may be separately manufactured. This improves manufacturing convenience. In addition, the first housing has the first groove, and the first conducting layer is disposed on the inner wall of the first groove. The second housing has the second groove, and the second conducting layer is disposed on the inner wall of the second groove. After the first housing and the second housing are fastened to each other, the first groove and the second groove may be fastened into the path used to accommodate the inner conductor. The first conducting layer and the second conducting layer may play a good electromagnetic shielding role in the inner conductor, and a signal is transmitted in the inner conductor. Therefore, this helps ensure signal transmission performance of the transmission line. In addition, a part of an edge of the support plate is fastened between the first housing and the second housing, the support plate can have a plate surface with a large area, and the inner conductor may be located on two plate surfaces of the support plate. Therefore, when the inner conductor is designed or manufactured, there are more possibilities in terms of a quantity, a location, a shape, and a size of the inner conductor. Therefore, this helps improve performance of the transmission line or extend performance of the transmission line. In addition, the support plate may have a small thickness. Therefore, a volume occupied by the support plate may be very small, and bad problems such as transmission dispersion caused by the support plate can be reduced or prevented. In addition, at least a part of an edge of the support plate is fastened between the first housing and the second housing. This helps ensure connection effect between the support plate and the outer housing, and improve convenience of manufacturing or assembling the transmission line.

During specific disposition, the support plate may be a thin film, that is, a thickness of the support plate may be small. This helps reduce bad problems such as transmission dispersion caused by the support plate.

In the first groove, an included angle between a side wall of the first groove and a bottom wall of the first groove is greater than 90°. When the first conducting layer is manufactured, it is helpful to lay a conducting material over the bottom wall and the side wall of the first groove. Correspondingly, in the second groove, an included angle between a side wall of the second groove and a bottom wall of the second groove is greater than 90°. When the second conducting layer is manufactured, it is helpful to lay a conducting material over the bottom wall and the side wall of the second groove.

In an example, the support plate may be attached to a top surface of the first groove. The support plate may be fastened to the top surface of the first groove, or the support plate may not be fastened to the top surface of the first groove.

Certainly, in an example, the first conducting layer may be located on a top surface of the first groove, and the support plate may be attached to the first conducting layer on the top surface of the first groove.

In an example, the support plate may be attached to a top surface of the second groove. The support plate may be fastened to the top surface of the second groove, or the support plate may not be fastened to the top surface of the second groove.

Certainly, in an example, the second conducting layer may be further located on a top surface of the second groove, and the support plate may be attached to the second conducting layer on the top surface of the second groove.

In an example, a top surface of the first groove may have a first sink, and at least a part of the support plate may be located in the first sink. A depth of the first sink may be greater than, equal to, or less than a thickness of the support plate. This is not limited in this disclosure.

Certainly, in an example, the first conducting layer may also be located on a bottom wall of the first sink. The support plate may be attached to the first conducting layer located on the bottom wall of the first sink. It may be understood that, when the first conducting layer is not disposed on the bottom wall of the first sink, the support plate may be attached to the bottom wall of the first sink.

In an example, a top surface of the second groove may have a second sink, and at least a part of the support plate may be located in the second sink. A depth of the second sink may be greater than, equal to, or less than a thickness of the support plate. This is not limited in this disclosure.

Certainly, in an example, the second conducting layer may also be located on a bottom wall of the second sink. The support plate may be attached to the second conducting layer located on the bottom wall of the second sink. It may be understood that, when the second conducting layer is not disposed on the bottom wall of the second sink, the support plate may be attached to the bottom wall of the second sink.

In an example, the support plate may have metalized holes that penetrate two sides of the support plate (that is, a thickness direction of the support plate), and the first conducting layer and the second conducting layer may be electrically connected through the metalized holes.

In an example, the transmission line may further include a functional device. The functional device may be disposed between the support plate and the inner conductor, and the functional device is electrically connected to the inner conductor, so that functionality of the transmission line can be expanded. In a specific application, the functional device may include any one of a resonant tunneling diode, a Schottky diode, and a quantum cascade laser. A location, a quantity, and a type of the functional device are not limited in this disclosure.

In addition, in a specific application, along a length direction of the inner conductor, a shape and a size of a cross section of the inner conductor almost do not change. Alternatively, along a length direction of the inner conductor, a shape of a cross section of the inner conductor may change, to implement different functions. For example, along a length direction of the transmission line, the inner conductor may have a periodic extending portion, so that effect of a filter or a slow-wave device can be achieved.

In addition, the transmission line may be in a shape, for example, a straight line or a curve. A shape of the transmission line is not limited in this disclosure.

According to a second aspect, this disclosure further provides a transmission cable, where the transmission cable may include at least three transmission lines of any one of the foregoing types, the at least three transmission lines include one first transmission line and at least two second transmission lines, and the at least two second transmission lines are separately connected to the first transmission line. Alternatively, the first transmission line may be used as a main line, and the at least two second transmission lines may be used as branches of the main line.

According to a third aspect, this disclosure further provides an electronic device, where the electronic device may include a substrate, one or more electronic components, and the transmission line provided in the first aspect. The one or more electronic components and the transmission line may be disposed on the substrate, and the electronic components may be connected to each other through the transmission line. Each electronic component may be connected to another external device or another external electronic component through the transmission line. Alternatively, when the electronic device includes a plurality of electronic components, different electronic components may be connected through the transmission line. The electronic device may be a base station, a server, or the like. A specific type of the electronic device is not limited in this disclosure.

In addition, this disclosure further provides a transmission line preparation method, and the method may include preparing a first groove on a surface of a first housing, disposing a first conducting layer on an inner wall of the first groove, disposing an inner conductor on at least one plate surface of a support plate, fastening, to an opening of the first groove, the support plate on which the inner conductor is disposed, preparing a second groove on a surface of a second housing, disposing a second conducting layer on an inner wall of the second groove, and fastening the first groove and the second groove.

In some preparation methods, the method may further include: preparing a first sink on a top surface of the first groove, or preparing a second recess on a top surface of the second groove.

The transmission line provided in embodiments of this disclosure may be manufactured by using a preparation process. This helps improve preparation convenience, and further helps ensure preparation quality. In addition, the transmission line may be a split structure. Therefore, different structures may be manufactured by using different preparation processes. This helps improve manufacturing efficiency and manufacturing precision, and helps ensure signal transmission performance of the transmission line.

### BRIEF DESCRIPTION OF DRAWINGS

FIG. 1 is a simple diagram of a structure of an electronic device according to an embodiment;

FIG. 2 is a diagram of a three-dimensional structure of a typical air-filled rectangular micro-coaxial transmission line;

FIG. 3 is a diagram of a three-dimensional structure of a transmission line according to an embodiment;

FIG. 4 is a diagram of a cross-sectional structure of a transmission line according to an embodiment;

FIG. 5 is a data diagram of comparison between a transmission loss of a transmission line and a transmission loss of a metal rectangular waveguide according to an embodiment;

FIG. 6 is a diagram of another cross-sectional structure of a transmission line according to an embodiment;

FIG. 7 is a diagram of another cross-sectional structure of a transmission line according to an embodiment;

FIG. 8 is a data diagram of comparison between transmission losses of two different transmission lines according to an embodiment;

FIG. 9 is a data diagram of comparison between transmission losses of two different transmission lines according to an embodiment;

FIG. 10 is a diagram of a three-dimensional structure of a transmission line according to an embodiment;

FIG. 11 is a plan diagram of displaying an inner conductor according to an embodiment;

FIG. 12 is a diagram of another cross-sectional structure of a transmission line according to an embodiment;

FIG. 13 is a diagram of another cross-sectional structure of a transmission line according to an embodiment;

FIG. 14 is a diagram of another cross-sectional structure of a transmission line according to an embodiment;

FIG. 15 is a data diagram according to an embodiment;

FIG. 16 is a diagram of another cross-section of an exploded structure of a transmission line according to an embodiment;

FIG. 17 is a diagram of another cross-section of an exploded structure of a transmission line according to an embodiment;

FIG. 18 is a diagram of another cross-sectional structure of a transmission line according to an embodiment;

FIG. 19 is a diagram of another three-dimensional structure of a transmission line according to an embodiment;

FIG. 20 is a diagram of another cross-sectional structure of a transmission line according to an embodiment;

FIG. 21 is a diagram of a three-dimensional structure of perspective effect of a transmission line according to an embodiment;

FIG. 22 is a diagram of a three-dimensional structure of perspective effect of a transmission cable according to an embodiment;

FIG. 23 is a distribution diagram of electric field strength of a transmission line perpendicular to a propagation direction according to an embodiment;

FIG. 24 is a distribution diagram of electric field strength of a transmission line parallel to a propagation direction according to an embodiment;

FIG. 25 is a distribution diagram of electric field strength of another transmission line parallel to a propagation direction according to an embodiment;

FIG. 26 is a distribution diagram of electric field strength of a transmission cable parallel to a propagation direction according to an embodiment;

FIG. 27 is a data diagram of comparison between insertion losses of different support plates according to an embodiment;

FIG. 28 is a diagram of simulation data of a group delay and dispersion of a transmission line according to an embodiment;

FIG. 29 is a flowchart of a transmission line preparation method according to an embodiment;

FIG. 30 is a diagram of a cross-sectional structure of a first housing according to an embodiment;

FIG. 31 is a diagram of cross-sectional structures of a support plate and a first housing according to an embodiment;

FIG. 32 is a diagram of a cross-sectional structure of a second housing according to an embodiment; and

FIG. 33 is a diagram of a cross-sectional structure of a transmission line according to an embodiment.

### DESCRIPTION OF EMBODIMENTS

To make the objectives, technical solutions, and advantages of this disclosure clearer, the following further describes this disclosure in detail with reference to accompanying drawings.

To facilitate understanding of a transmission line provided in embodiments of this disclosure, the following first describes application scenarios of the transmission line.

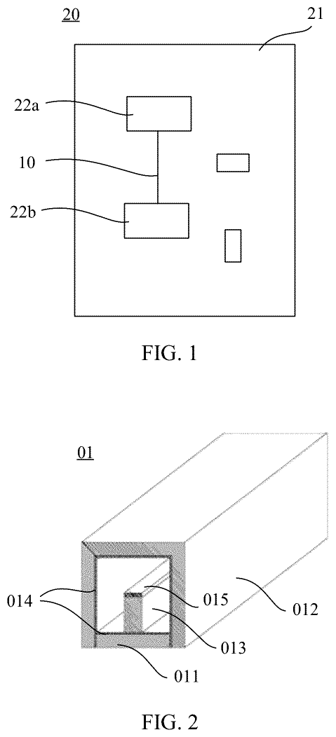

FIG. 1 is a simple diagram of a structure of an electronic device 20 according to an embodiment of this disclosure. A transmission line may be used in the electronic device 20, and is configured to implement signal connection between electronic components in the electronic device 20. Specifically, the electronic device 20 may include a substrate 21, a first electronic element 22a, a second electronic element 22b, and a transmission line 10. The first electronic element 22a, the second electronic element 22b, and the transmission line 10 are all disposed on the substrate 21, one end of the transmission line is connected to the first electronic element 22a, and the other end of the transmission line is connected to the second electronic element 22b. That is, a signal connection between the first electronic element 22a and the second electronic element 22b may be implemented through the transmission line 10. The first electronic element 22a or the second electronic element 22b may be an active device, or may be a passive device, or the like. Specific types of the first electronic element 22a and the second electronic element 22b are not limited in this disclosure.

Currently, there are various types of transmission lines, and different types of transmission lines have different transmission features, and can be used in different types of application scenarios.

For example, the transmission line may include a microstrip, a coplanar waveguide, or a coplanar stripline. Because the microstrip, the coplanar waveguide, or the coplanar stripline has a good transmission feature in a low frequency band, the microstrip, the coplanar waveguide, or the coplanar stripline is widely used in a microwave integrated circuit. With continuous development of science and technology and continuous improvement of market demand, the integrated circuit gradually develops into a high frequency band. However, when a working frequency of some approaches of a transmission line (for example, the foregoing microstrip) is increased to a millimeter band or even a terahertz band, transmission losses increase exponentially, and poor cases such as a high-order mode and large dispersion occur. Therefore, in some approaches, the transmission line cannot meet a transmission requirement of a high working frequency.

The transmission line may further include a metal rectangular waveguide. The metal rectangular waveguide is usually made of a metal material, for example, copper or aluminum, and is a regular metal waveguide with a rectangular cross section shape and filled with an air medium.

The metal rectangular waveguide has advantages of a low transmission loss, a large power capacity, and the like when being used as a transmission line, but the metal rectangular waveguide has many problems such as difficult mechanical processing, a large size, and a large weight.

With development of processing technology, a new type of air-filled rectangular micro-coaxial transmission line emerges, and is expected to resolve problems such as high frequency signal transmission losses of some approaches of the transmission line and a large size and weight of the metal rectangular waveguide. In addition, because the air-filled rectangular micro-coaxial transmission line has advantages such as low cutoff frequency (close to zero) and high electromagnetic shielding, the air-filled rectangular micro-coaxial transmission line has gradually become a mainstream research direction.

FIG. 2 is a diagram of a three-dimensional structure of a typical air-filled rectangular micro-coaxial transmission line 01. The air-filled rectangular micro-coaxial transmission line 01 mainly includes an outer frame bottom plate 011, an outer frame cap 012, a support structure 013, outer conductors 014, and an inner conductor 015. The outer frame bottom plate 011 and the outer frame cap 012 form a cavity structure with a rectangular cross section, and an outer conductor 014 is disposed on each of an upper plate surface of the outer frame bottom plate 011 and an inner wall of the outer frame cap 012. The inner conductor 015 is fastened in a rectangular path by using the support structure 013.

In the foregoing air-filled rectangular micro-coaxial transmission line 01, because the support structure 013 has a large volume, transmission dispersion of the air-filled rectangular micro-coaxial transmission line 01 is increased. If the volume of the support structure 013 is reduced, performance of the air-filled rectangular micro-coaxial transmission line 01 is adversely affected. For example, after a width of the support structure 013 is reduced, the support structure 013 cannot provide a sufficient top surface area, and a size and a shape of the inner conductor 015 are greatly restricted. In addition, after a height of the support structure 013 is reduced, the inner conductor 015 is closer to the outer frame bottom plate 011. This causes higher transmission losses.

In addition, during manufacturing, the outer frame bottom plate 011 and the outer frame cap 012 are usually manufactured by using a light-cured liquid resin material and a 3D printing process. However, surface flatness manufactured in this manufacturing manner is low. This affects manufacturing quality of the inner conductor 015 and the outer conductor 014, increases transmission losses, and further causes a bad situation, for example, transmission dispersion. In addition, signal transmission performance (for example, transmission losses) of the air-filled rectangular micro-coaxial transmission line 01 is basically the same as transmission performance of a metal rectangular waveguide.

Certainly, there are still other different types of transmission lines in the current transmission line. However, the current transmission line structure does not facilitate miniaturization and lightening design, and does not facilitate manufacturing.

Therefore, embodiments of this disclosure provide a transmission line that has a simple structure and facilitates miniaturization and lightening design.

To make the objectives, technical solutions, and advantages of this disclosure clearer, the following further describes this disclosure in detail with reference to accompanying drawings and specific embodiments.

Terms used in the following embodiments are only intended to describe specific embodiments, but are not intended to limit this disclosure. Terms “one”, “a”, and “this” of singular forms used in this specification and the appended claims of this disclosure are also intended to include a form like “one or more”, unless otherwise specified in the context clearly. It may be further understood that, in the following embodiments of this disclosure, “at least one” means one, two, or more.

Reference to “an embodiment” or the like described in this specification means that one or more embodiments of this disclosure include a particular feature, structure, or characteristic described in combination with the embodiment. Therefore, in this specification, statements, such as “in an embodiment”, “in some implementations”, and “in other implementations”, that appear at different places do not necessarily mean referring to a same embodiment, instead, the statements mean referring to “one or more but not all of embodiments”, unless otherwise specifically emphasized in other ways. Terms “include”, “have”, and variants of the terms all mean “include but are not limited to”, unless otherwise specifically emphasized in other ways.

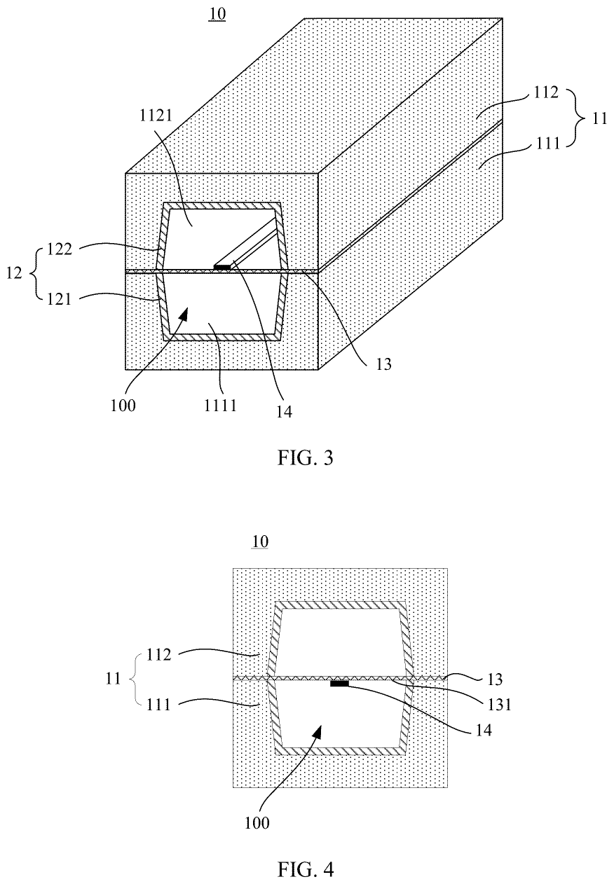

As shown in FIG. 3 and FIG. 4, in an example provided in this disclosure, the transmission line 10 may include an outer housing 11, an outer conductor 12, a support plate 13, and an inner conductor 14. Specifically, the outer housing 11 may include a first housing 111 and a second housing 112 that are fastened to each other. The first housing 111 has a first groove 1111, the second housing 112 has a second groove 1121, and the first groove 1111 and the second groove 1121 are enclosed to form a path 100. The outer conductor 12 may include a first conducting layer 121 and a second conducting layer 122, where the first conducting layer 121 is located on an inner wall of the first groove 1111, and the second conducting layer 122 is located on an inner wall of the second groove 1121. The support plate 13 is suspended in the path 100, and at least a part of an edge of the support plate 13 is fastened between the first housing 111 and the second housing 112. The inner conductor 14 is disposed on a first plate surface 131 (a lower plate surface in FIG. 4) of the support plate 13.

In the transmission line 10 provided in this disclosure, the outer housing 11 of the transmission line 10 includes the first housing 111 and the second housing 112. Therefore, during manufacturing, the first housing 111 and the second housing 112 may be separately manufactured. This improves manufacturing convenience. In addition, the first housing 111 has the first groove 1111, and the first conducting layer 121 is disposed on the inner wall of the first groove 1111. The second housing 112 has the second groove 1121, and the second conducting layer 122 is disposed on the inner wall of the second groove 1121. After the first housing 111 and the second housing 112 are fastened to each other, the first groove 1111 and the second groove 1121 may be fastened together and into the path 100 used to accommodate the inner conductor 14. The first conducting layer 121 and the second conducting layer 122 may play a good electromagnetic shielding role in the inner conductor 14. This helps ensure signal transmission performance of the transmission line 10 when a signal is transmitted in the inner conductor 14.

In addition, that the support plate 13 is suspended in the path 100 specifically means that the support plate 13 may be fastened to the first housing 111, or the support plate 13 may be fastened to the second housing 112, or the support plate 13 may be fastened to the first housing 111 and the second housing 112. In addition, a part of an edge of the support plate 13 is fastened between the first housing 111 and the second housing 112, the support plate 13 can have a plate surface with a large area, and the inner conductor 14 may be located on two plate surfaces of the support plate 13. Therefore, when the inner conductor 14 is designed or manufactured, there are more possibilities in terms of a quantity, a location, a shape, and a size of the inner conductor 14. Therefore, this helps improve performance of the transmission line 10 or extend performance of the transmission line 10. In addition, the support plate 13 may have a small thickness. Therefore, a volume occupied by the support plate 13 may be very small, and bad problems such as transmission dispersion caused by the support plate 13 can be reduced or prevented. In addition, at least a part of an edge of the support plate 13 is fastened between the first housing 111 and the second housing 112. This helps ensure connection effect between the support plate 13 and the outer housing 11, and improve convenience of manufacturing or assembling the transmission line 10.

To clearly reflect technical effect of the transmission line 10, this embodiment further provides a data diagram of comparison between transmission losses of the transmission line 10 and a metal rectangular waveguide.

As shown in FIG. 5, a horizontal coordinate indicates a frequency in a unit of terahertz (THz), and a vertical coordinate indicates a transmission loss in a unit of decibels per millimeter (dB/mm), that is, a transmission loss of per millimeter of a transmission line 10. A solid line in FIG. 5 indicates a simulation curve corresponding to a transmission loss and a frequency of the transmission line 10 provided in this embodiment. A dashed line indicates a simulation curve corresponding to a transmission loss and a frequency of a metal rectangular waveguide.

It can be seen from FIG. 5 that the transmission line 10 provided in this embodiment implements features of a low loss (for example, about 0.1 dB/mm) and a large bandwidth (for example, reaching 1 THz), and a transmission loss in a frequency band above 300 gigahertz (GHz) is far lower than that of a metal rectangular waveguide. Alternatively, it may be understood that, when the transmission line 10 provided in this embodiment operates in a frequency range from a direct current to THz, the transmission line 10 has features of low dispersion and large bandwidth.

In a specific application, an overall structure of the transmission line 10 and structures and disposition manners of the outer housing 11, the outer conductor 12, the support plate 13, and the inner conductor 14 may be diversified, and the following separately provides examples for description.

Refer to FIG. 3 and FIG. 4. For the support plate 13, in a specific application, the support plate 13 may be a plate body structure, that is, the support plate 13 may have an obvious thickness, so that a large support force can be provided for the inner conductor 14. Alternatively, the support plate 13 may be a thin film (for example, a thickness is less than or equal to 5 μm), so that the support plate 13 has a small thickness, helping reduce a transmission loss and dispersion of the transmission line 10. During manufacturing, the support plate 13 may be obtained by cutting a thin film with a large area, so that the support plate 13 can be manufactured in batches, and quality consistency can be ensured. When a material of the support plate 13 is selected, a material with a low dielectric constant (for example, a dielectric constant is 2, 3, or 4) may be selected. Alternatively, the support plate 13 may be made of a rigid material, to ensure connection stability between the inner conductor 14 and the outer housing 11. Alternatively, the support plate 13 may be a flexible material. When the transmission line 10 is impacted by a large external force, the support plate 13 may buffer and absorb the external force through elastic deformation of the support plate 13, to prevent the transmission line 10 from being damaged. Certainly, a specific material of the support plate 13 is not limited in this disclosure. In addition, a thickness of the support plate 13 may be 5 μm, or may be greater than 5 or less than 5. A thickness of the support plate 13 is not limited in this disclosure. In an actual application, a thickness, a shape, and a material of the support plate 13 may be properly selected based on different requirements, and details are not described herein.

For the inner conductor 14, in a specific application, a signal is mainly transmitted in the inner conductor 14. Therefore, the inner conductor 14 may be manufactured by using a material with good conductivity, for example, copper, nickel, gold, titanium, chromium, and palladium. During manufacturing, the inner conductor 14 may be directly prepared on the support plate 13 by using a deposition process such as electron beam evaporation or magnetron sputtering. Alternatively, the prepared and formed inner conductor 14 may also be disposed on the support plate 13. A material and a preparation process of the inner conductor 14 are not limited in this disclosure.

In addition, in a specific application, shapes and types of the inner conductor 14 may be diversified.

For example, as shown in FIG. 4, in an example provided in this disclosure, the inner conductor 14 may be disposed on the first plate surface 131 of the support plate 13.

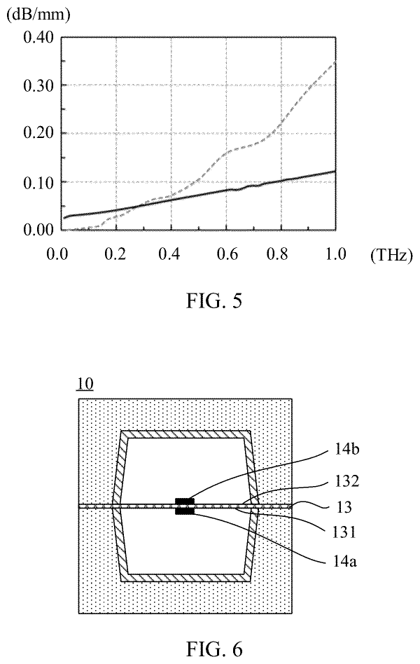

Alternatively, as shown in FIG. 6, in an example provided in this disclosure, inner conductors may be disposed on the first plate surface 131 and a second plate surface 132 of the support plate 13. Specifically, the inner conductors are separately an inner conductor 14a and an inner conductor 14b. The inner conductor 14a is located on the first plate surface 131 of the support plate 13, the inner conductor 14b is located on the second plate surface 132 of the support plate 13, and a vertical projection of the inner conductor 14a on the second plate surface 132 overlaps the inner conductor 14b.

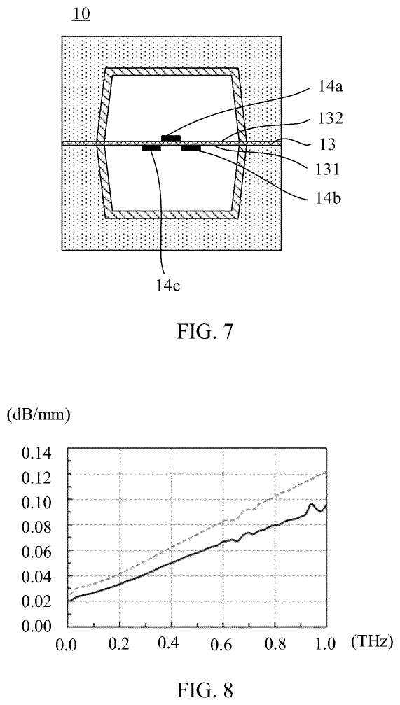

Alternatively, as shown in FIG. 7, in an example provided in this disclosure, three inner conductors are disposed: an inner conductor 14a, an inner conductor 14b, and an inner conductor 14c. The inner conductor 14b and the inner conductor 14c are located on the first plate surface 131 of the support plate 13, the inner conductor 14a is located on the second plate surface 132 of the support plate 13, and a vertical projection of the inner conductor 14a on the first plate surface 131 does not overlap the inner conductor 14b and the inner conductor 14c.

In a specific application, a quantity of disposed inner conductors 14 is increased, to help reduce a transmission loss of the transmission line 10.

For example, as shown in FIG. 8, an embodiment provides a data diagram of comparison between transmission losses of the transmission line 10 in FIG. 4 and FIG. 6.

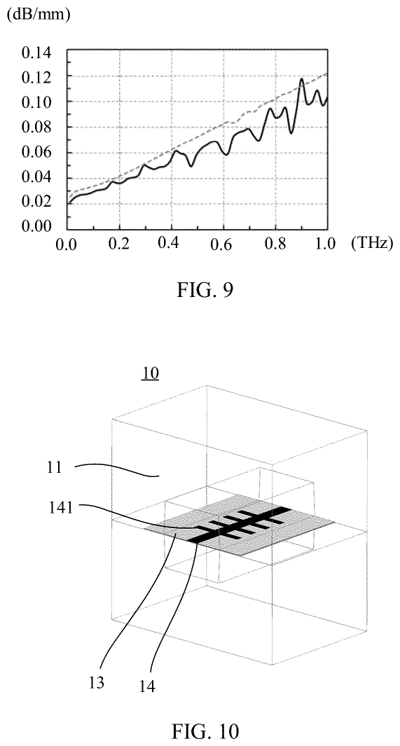

As shown in FIG. 9, an embodiment provides a data diagram of comparison between transmission losses of the transmission line 10 in FIG. 4 and FIG. 7.

In FIG. 8 and FIG. 9, a horizontal coordinate indicates a frequency in a unit of THz, and a vertical coordinate indicates a transmission loss in a unit of dB/mm, that is, a transmission loss of per millimeter of a transmission line 10.

In FIG. 8, a dashed line indicates a simulation curve corresponding to a transmission loss and a frequency of the transmission line 10 in FIG. 4. A solid line indicates a simulation curve corresponding to a transmission loss and a frequency of the transmission line 10 in FIG. 6.

In FIG. 9, a dashed line indicates a simulation curve corresponding to a transmission loss and a frequency of the transmission line 10 in FIG. 4. A solid line indicates a simulation curve corresponding to a transmission loss and a frequency of the transmission line 10 in FIG. 7.

It may be clearly learned from comparison that, when a quantity of inner conductors 14 is increased, a transmission loss of the transmission line 10 may be reduced.

Certainly, in another implementation, the transmission line 10 may further include more inner conductors 14.

In conclusion, in an actual application, the inner conductor 14 may be disposed on the first plate surface 131 of the support plate 13, or may be disposed only on the second plate surface 132 of the support plate 13, or may be disposed on each of the first plate surface 131 and the second plate surface 132 of the support plate 13.

In addition, there may be one, two, three, or more inner conductors 14. This is not limited in this disclosure.

Along a length direction (or a signal transmission direction) of the inner conductor 14, shapes of cross-sections of the inner conductor 14 may be consistent.

For example, in the examples shown in FIG. 3 and FIG. 4, shapes of cross-sections of the inner conductor 14 are rectangular sheets, and shapes and sizes of cross sections of the inner conductor 14 almost do not change along the length direction of the inner conductor 14.

Certainly, in another example, along a length direction of the inner conductor 14, a shape of a cross-section of the inner conductor 14 may change, to implement different functions.

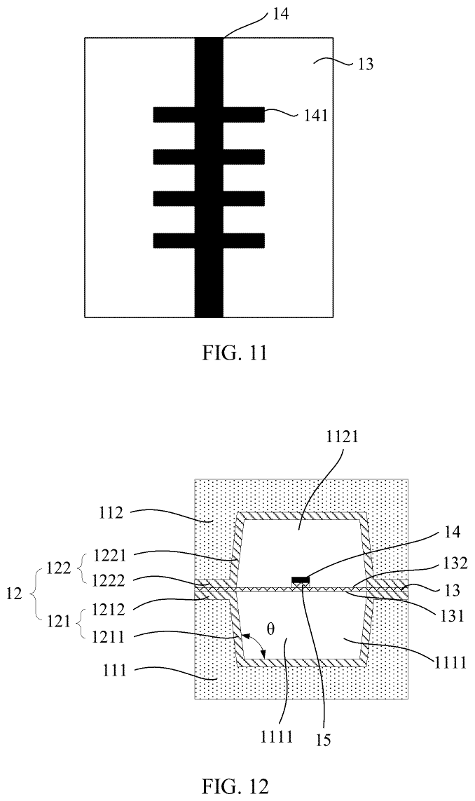

For example, FIG. 10 is a diagram of a three-dimensional structure of a transmission line, and FIG. 11 is a plan view of showing the inner conductor 14. Along a length direction of the transmission line 10, the inner conductor 14 has periodic extending portions 141, so that effect of a filter or a slow-wave device can be achieved. Specifically, in the example in FIG. 11, four extending portions 141 are shown, and the four extending portions 141 are disposed at an equal distance. Certainly, in another implementation, a shape, a quantity, and a location of the extending portion 141 may be properly set based on an actual requirement. Alternatively, it may be understood that, in a specific application, because the support plate 13 can provide a size of a plate surface with a large area, more possibilities are provided when a shape of the inner conductor 14 is designed, to help flexibly design the shape of the inner conductor 14, to extend a function of the transmission line 10.

In addition, in some implementations, some functional devices may be disposed between the inner conductor 14 and the support plate 13, to extend a function of the transmission line 10.

For example, as shown in FIG. 12, in an example provided in this disclosure, the functional device 15 may be disposed between the support plate 13 and the inner conductor 14, and the inner conductor 14 is electrically connected to the functional device 15.

The functional device 15 may include any one of a resonant tunneling diode, a Schottky diode, and a quantum cascade laser. In an actual application, the transmission line 10 may include one, two, or more functional devices 15. A type and a quantity of the functional devices 15 are not limited in this disclosure.

During manufacturing, the functional device 15 may be directly prepared on a surface of the support plate 13. For example, an epitaxial layer may be grown on the surface of the support plate 13, to directly prepare the functional device, and then the inner conductor 14 is prepared on the functional device 5. Alternatively, the prepared and formed functional device 15 may be disposed on the support plate 13. A manner of preparing the functional device 15 is not limited in this disclosure.

In a specific application of the outer housing 11, there may also be various structure types of the outer housing 11.

For example, as shown in FIG. 12, in an example provided in this disclosure, structures of the first housing 111 and the second housing 112 are approximately the same.

The first housing 111 is used as an example, and the first groove 1111 of the first housing 111 is in an open shape. Alternatively, it may be understood that an included angle θ between a bottom wall of the first groove 1111 and a side wall of the first groove 1111 is greater than 90°, to help prepare the first conducting layer 121.

For example, when a metal material is deposited on an inner wall of the first groove 1111 by using a metal vapor deposition process, the metal material may be effectively deposited on the bottom wall and the side wall of the first groove 1111 under an action of gravity. On the contrary, if the included angle θ between the bottom wall of the first groove 1111 and the side wall of the first groove 1111 is 90° or less than 90°, when the first conducting layer 121 is prepared by using the metal vapor deposition process, it is difficult or cannot effectively deposit the metal material in all areas of the bottom wall and the side wall of the first groove 1111. Therefore, in this embodiment provided in this disclosure, the first groove 1111 is disposed as an open structure, so that the first conducting layer 121 is effectively prepared on the bottom wall and the side wall of the first groove 1111.

In an actual application, the included angle θ between the bottom wall of the first groove 1111 and the side wall of the first groove 1111 may be about 93°. Certainly, a specific value of 0 is not limited in this disclosure. Alternatively, in another example, a shape of a cross-section of the first groove 1111 or the second groove 1121 may be an arc, a triangle, an elliptical arc, another irregular shape, or the like. Details are not described herein.

In addition, when the first conducting layer 121 is disposed, the first conducting layer 121 may also be located outside the first groove 1111.

For example, as shown in FIG. 12, in an example provided in this disclosure, the first conducting layer 121 is located on an inner wall (including a bottom wall and a side wall) of the first groove 1111 and a top surface of the first groove 1111. The second conducting layer 122 is located on an inner wall (including a bottom wall and a side wall) of the second groove 1121 and a top surface of the second groove 1121. Alternatively, it may be understood that the first conducting layer 121 includes a first part 1211 located on an inner wall of the first groove 1111 and a second part 1212 located on a top surface of the first groove 1111. The second conducting layer 122 includes a first part 1221 located on an inner wall of the second groove 1121, and a second part 1222 located on a top surface of the second groove 1121.

The support plate 13 may be located between the second part 1212 and the second part 1222. The first plate surface 131 of the support plate 13 may be fastened to the second part 1212 of the first conducting layer 121. Alternatively, the second plate surface 132 of the support plate 13 may be fastened to the second part 1222 of the second conducting layer 122. During specific disposing, the support plate 13 may be fastened to the first conducting layer 121 or the second conducting layer 122 in a manner of bonding, welding, or the like. This is not limited in this application.

Certainly, during specific implementation, the first conducting layer 121 may be in ohmic contact with the second conducting layer 122, and the first conducting layer 121 may not be in ohmic contact with the second conducting layer 122 (that is, conducting connection). In the example provided in FIG. 12, the first conducting layer 121 is not in ohmic contact with the second conducting layer 122.

When the first conducting layer 121 is in ohmic contact with the second conducting layer 122, there may be a plurality of implementations.

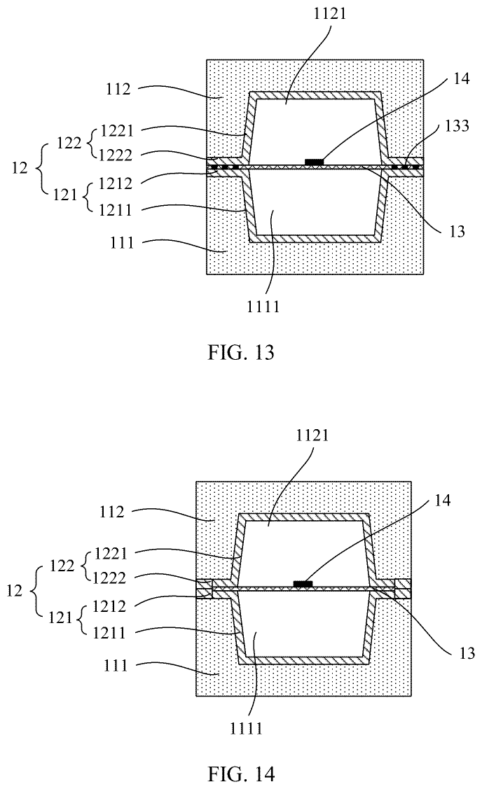

For example, as shown in FIG. 13, in an example provided in this disclosure, the first conducting layer 121 may be in ohmic contact with the second conducting layer 122 through metalized holes 133.

Specifically, the metalized holes 133 that penetrate two sides of the support plate 13 may be disposed in the support plate 13, and the first conducting layer 121 is in ohmic contact with the second conducting layer 122 through the metalized holes 133.

It may be understood that, in another implementation, the metalized holes 133 may also be replaced with conducting wires or the like. Details are not described herein again.

Alternatively, as shown in FIG. 14, the second part 1212 of the first conducting layer 121 and the second part 1222 of the second conducting layer 122 each are provided with a sink (not marked in the figure), the support plate 13 is located in the sink, and the second part 1212 is in contact with the second part 1222. Alternatively, it may be understood that a width of the support plate 13 (a size in a left-right direction in the figure) is less than a width of the first housing 111 and a width of the second housing 112. A thickness of the support plate 13 is approximately equal to a sum of depths of the sinks of the second part 1212 and the second part 1222. Therefore, the support plate 13 can be clamped between partial areas of the second part 1212 and the second part 1222, and the partial areas the second part 1212 and the second part 1222 can also be effectively attached, to implement an electrical connection between the first conducting layer 121 and the second conducting layer 122.

Certainly, in a specific application, because the thickness of the support plate 13 may be small, when the first conducting layer 121 is not in ohmic contact with the second conducting layer 122, an external electromagnetic wave is not effectively propagated to the inner conductor 14, and an electromagnetic wave in the inner conductor 14 does not leak. After the first conducting layer 121 is in ohmic contact with the second conducting layer 122, the first conducting layer 121 and the second conducting layer 122 may improve electromagnetic shielding effect for the inner conductor 14, prevent an external electromagnetic wave from propagating to the inner conductor 14, and also prevent the electromagnetic wave in the inner conductor 14 from leaking out. This helps ensure signal transmission performance of the transmission line 10.

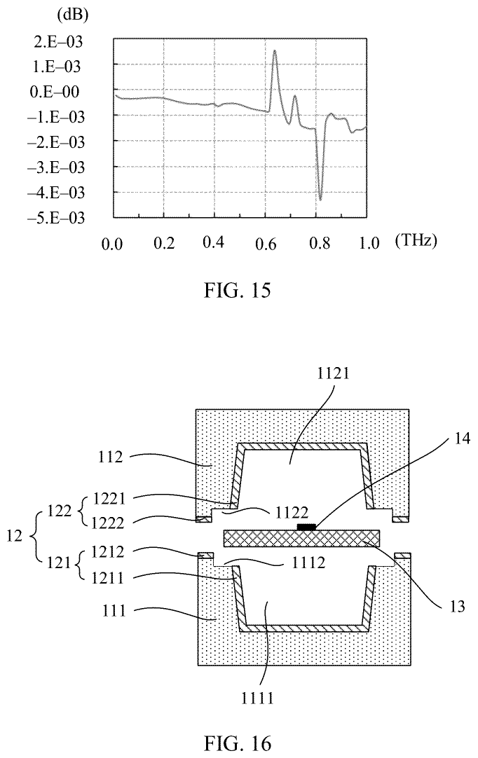

As shown in FIG. 15, a data diagram is provided to compare a difference between an insertion loss in a case that the first conducting layer 121 is in ohmic contact with the second conducting layer 122 and an insertion loss in a case that the first conducting layer 121 is not in ohmic contact with the second conducting layer 122 for a transmission line 10 with a length of 1 mm.

In FIG. 15, a horizontal coordinate indicates a frequency in a unit of THz, and a vertical coordinate indicates a difference between insertion losses in a unit of dB. For example, 2.E-03 specifically indicates 2*10⁻³, and −5.E-03 specifically indicates −5*10⁻³. Details are not described herein.

It can be seen from FIG. 15 that whether the first conducting layer 121 is in ohmic contact with the second conducting layer 122 has little impact on the insertion loss of the transmission line 10.

It may be understood that, in a specific application, whether the first conducting layer 121 is in ohmic contact with the second conducting layer 122 may be flexibly selected based on an actual requirement (for example, an electromagnetic shielding performance requirement or the thickness of the support plate 13).

Certainly, when the first housing 111 and the second housing 112 are disposed, structures of the first housing 111 and the second housing 112 may be diversified.

For example, as shown in FIG. 16, in another example provided in this disclosure, a first sink 1112 may be disposed on a top surface of the first groove 1111, and a second sink 1122 may be disposed on a top surface of the second groove 1121.

The support plate 13 may be located in the first sink 1112 and the second sink 1122, and the second part 1212 may be in ohmic contact with the second part 1222. In a specific application, a sum of a depth of the first sink 1112, a depth of the second sink 1122, a thickness of the second part 1212, and a thickness of the second part 1222 is greater than or equal to a thickness of the support plate 13, so that the second part 1212 is in good ohmic contact with the second part 1222.

It may be understood that, in a specific application, the second part 1212 may be fastened to the second part 1222 by using a bonding or welding process, to improve stability of a connection between the first housing 111 and the second housing 112, and ensure effect of an electrical connection between the second part 1212 and the second part 1222.

Certainly, in some implementations, the second part 1212 and the second part 1222 may also be omitted.

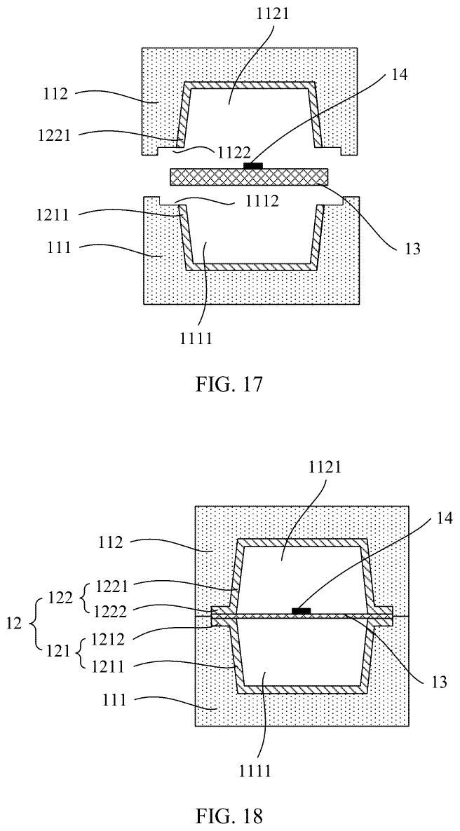

Specifically, as shown in FIG. 17, a sum of depths of the first sink 1112 and the second sink 1122 may be approximately equal to a thickness of the support plate 13, and a top surface of the first groove 1111 may be in contact with a top surface of the second groove 1121. The top surface of the first groove 1111 may be fastened to the top surface of the second groove 1121 by using a process such as bonding or welding, to improve connection stability between the first housing 111 and the second housing 112.

In addition, as shown in FIG. 18, in another example provided in this disclosure, the second part 1212 of the first conducting layer 121 may be further located on a bottom wall of the first sink (not shown in the figure), and the second part 1222 of the second conducting layer 122 may be further located on a bottom wall of the second sink (not shown in the figure).

Certainly, in a specific application, the first sink 1112 may be disposed only on a top surface of the first groove 1111, or the second sink 1122 may be disposed only on a top surface of the second groove 1121, or the first sink 1112 and the second sink 1122 may be disposed at the same time.

In addition, when the first housing 111 and the second housing 112 are disposed, structures of the first housing 111 and the second housing 112 may be the same, or may be different. This is not specifically limited in this disclosure.

In addition, it should be noted that, in an actual application, the first housing 111, the second housing 112, the outer conductor 12, the support plate 13, the inner conductor 14, and the like of the foregoing different structure types may be flexibly combined based on different requirements, and details are not described herein.

As shown in FIG. 19, for the entire transmission line 10, in an actual application, the transmission line 10 may be a straight line.

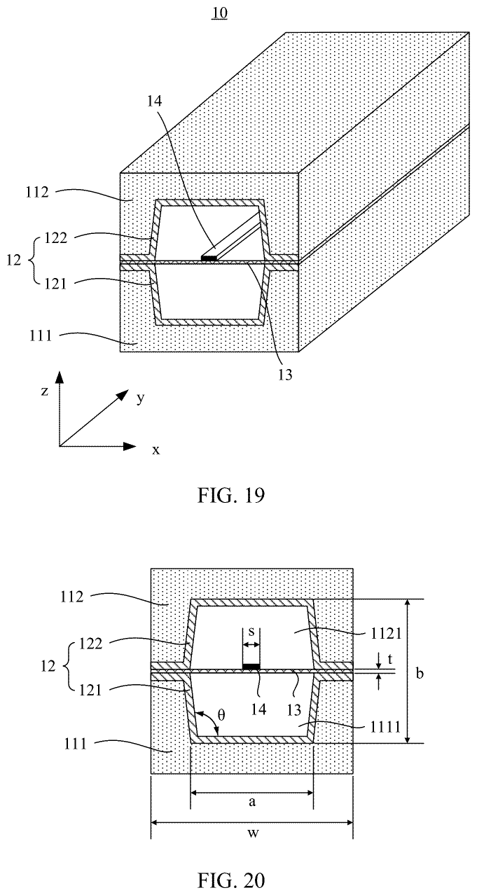

As shown in FIG. 20, a width a of a bottom wall of the first groove 1111 (or the second groove 1121) may be about 0.5 mm. A distance b between the bottom wall of the first groove 1111 and the bottom wall of the second groove 1121 may be about 0.5 mm. The included angle θ between the bottom wall and a side wall of the first groove 1111 (or the second groove 1121) may be about 93°. A width w of the support plate 13 may be about 0.9 mm. A thickness t of the support plate 13 may be about 5 μm. A relative dielectric constant & of the support plate 13 may be 2, 3, 4, or the like. A width s of the inner conductor 14 may be about 0.1 mm. Thicknesses of the outer conductor 12 and the inner conductor 14 may be about 0.5 μm. The thicknesses of the outer conductor 12 and the inner conductor 14 may be the same or may be different. This is not specifically limited in this disclosure.

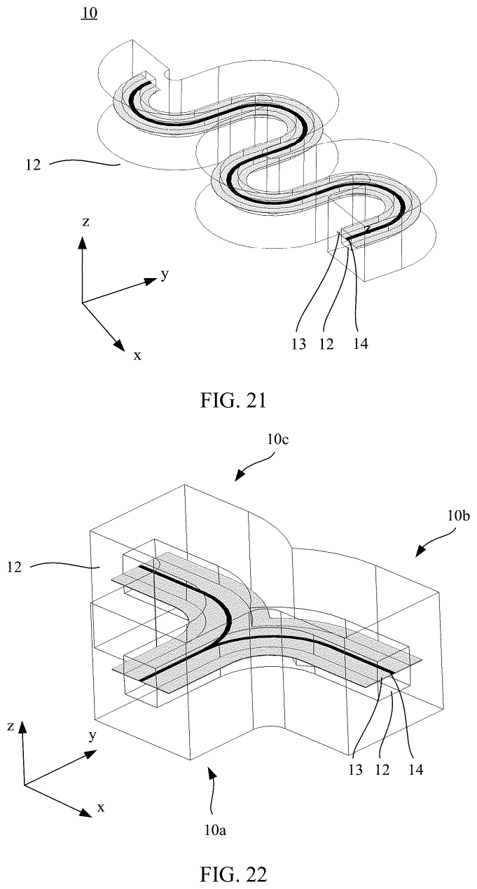

Alternatively, as shown in FIG. 21, the transmission line 10 may be S-shaped or the like.

Certainly, the transmission line 10 may be a flexible structure, and may be randomly bent or the like based on an actual construction requirement. Alternatively, it may be understood that an overall shape of the transmission line 10 is not limited in this disclosure.

In addition, as shown in FIG. 22, another transmission cable provided in this disclosure may include three transmission lines: a transmission line 10a, a transmission line 10b, and a transmission line 10c. The transmission line 10b and the transmission line 10c are separately connected to the transmission line 10a. That is, the transmission cable may be a Y-shaped structure. The transmission line 10a may be used as a main line, and the transmission line 10b and the transmission line 10c may be used as branches of the main line. Certainly, in another example, the transmission cable may further include three or more branches. Alternatively, each branch may include two or more branches, and details are not described herein.

In addition, for ease of describing technical effect of the transmission line 10, this embodiment further provides several simulation effect diagrams of electric field strength of the transmission line 10.

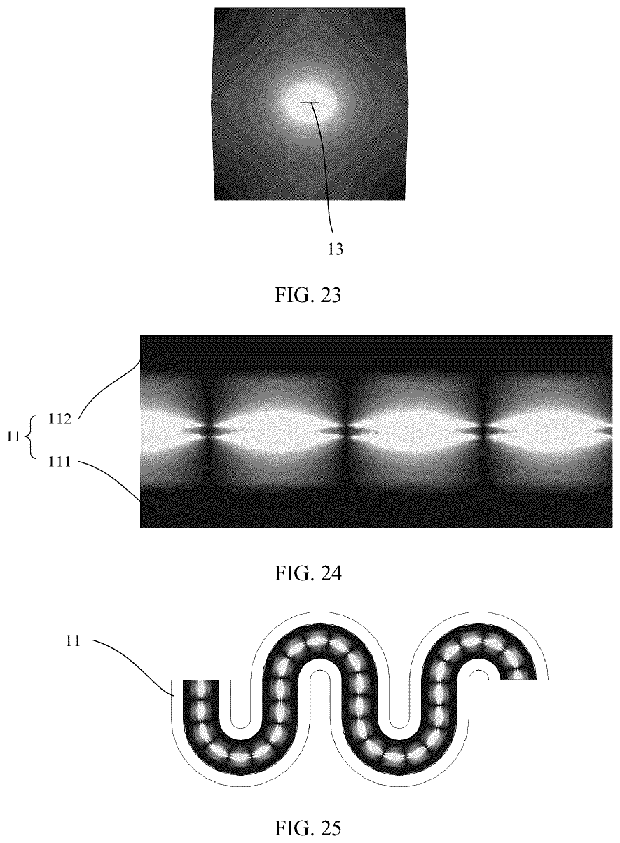

FIG. 23 is a distribution diagram of electric field strength of a cross section perpendicular to a length direction of a transmission line in a case that a signal is propagated in the transmission line in FIG. 19. That is, the distribution diagram of the electric field strength on the x-z plane.

FIG. 24 is a distribution diagram of electric field strength along a length direction of a transmission line in a case that a signal is propagated in the transmission line in FIG. 19. That is, the distribution diagram of the electric field strength on the x-y plane.

FIG. 25 is a distribution diagram of electric field strength along a length direction of a transmission line in a case that a signal is propagated in the transmission line in FIG. 21. That is, the distribution diagram of the electric field strength on the x-y plane.

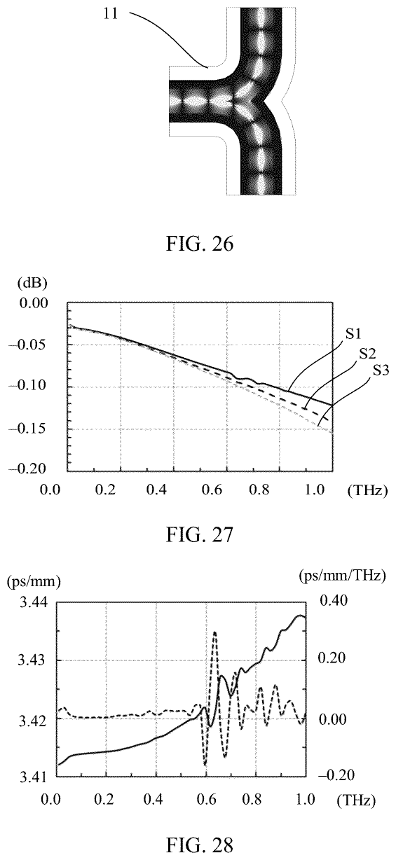

FIG. 26 is a distribution diagram of electric field strength along a length direction of a transmission line in a case that a signal is propagated in the transmission cable in FIG. 22. That is, the distribution diagram of the electric field strength on the x-y plane.

In FIG. 23 to FIG. 26, a lighter color indicates higher electric field strength, and on the contrary, a darker color indicates lower electric field strength. It can be seen that the electric field is basically concentrated around the inner conductor, distribution of the electric field is uniform and approximate to a quasi-transverse electromagnetic (TEM) mode, and is not affected by the support plate.

In addition, to test an insertion loss generated by the support plate 13, this embodiment further provides insertion losses of the support plate 13 with different dielectric constants.

In FIG. 27, insertion losses of three support plates with different dielectric constants of about a length of 1 mm are further provided, and a working frequency in a test is about 250 GHz.

In FIG. 27, a horizontal coordinate indicates a frequency in a unit of THz, and a vertical coordinate indicates an insertion loss in a unit of dB. A simulation curve S1 indicates a correspondence between an insertion loss and a frequency of the support plate 13 in a case that the dielectric constant is 2. A simulation curve S2 indicates a correspondence between an insertion loss and a frequency of the support plate in a case that the dielectric constant is 3. A simulation curve S3 indicates a correspondence between an insertion loss and a frequency of the support plate in a case that the dielectric constant is 4.

It can be seen from FIG. 27 that the insertion losses of the three support plates 13 with different dielectric constants are low. Therefore, distribution of an electric field is not affected, and signal transmission performance of the transmission line 10 is not affected. In addition, when a working frequency of the transmission line 10 is 1 THz, a small insertion loss can also be implemented.

In addition, as shown in FIG. 28, an embodiment further provides a diagram of simulation data of a group delay and dispersion of the transmission line 10.

In FIG. 28, a horizontal coordinate indicates a frequency in a unit of THz, and a left vertical coordinate indicates the group delay in a unit of ps/mm. A right vertical coordinate indicates the dispersion in the unit of ps/mm/THz. A solid line indicates a correspondence between a group delay and a frequency of the transmission line 10. A dashed line indicates a correspondence between dispersion and a frequency of the transmission line 10.

It can be seen from FIG. 28 that a group delay of the transmission line 10 changes very little in a large bandwidth of 1 THz, and a calculated theoretical dispersion average value of the group delay is 0.03 ps/mm/THz. This verifies that the transmission line 10 provided in this embodiment has a feature of low dispersion.

In conclusion, the transmission line 10 provided in this embodiment has good signal transmission performance, and an insertion loss generated by the support plate 13 is low, or may even be ignored. Therefore, signal transmission performance of the transmission line 10 is not affected.

When the transmission line 10 is manufactured, a plurality of different processes and methods may be used.

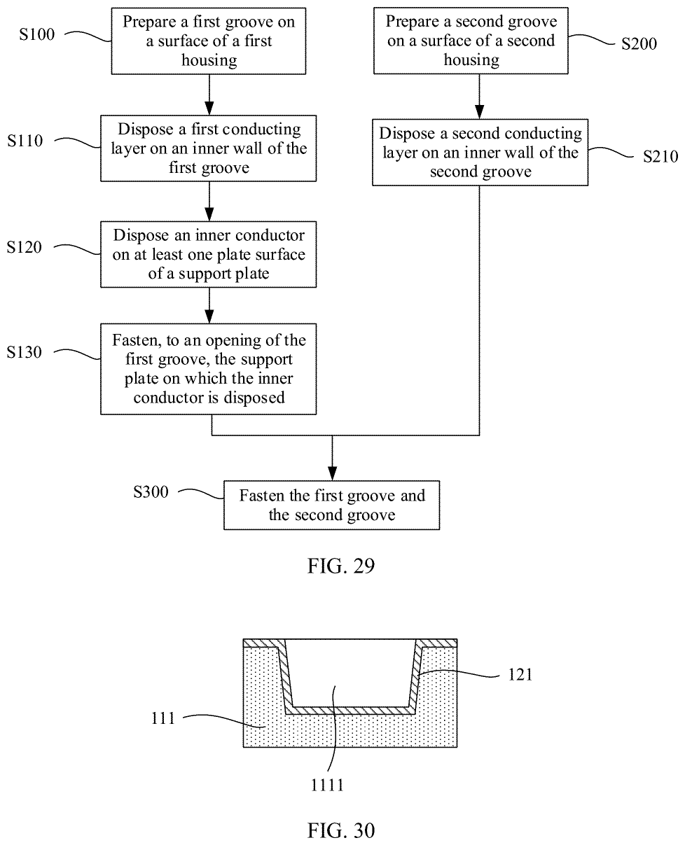

For example, as shown in FIG. 29, in an example provided in this disclosure, the preparation method may include the following steps.

Step S100: Prepare a first groove on a surface of a first housing.

Step S110: Dispose a first conducting layer on an inner wall of the first groove.

Step S120: Dispose an inner conductor on at least one plate surface of the support plate.

Step S130: Fasten, to an opening of the first groove, the support plate on which the inner conductor is disposed.

Step S200: Prepare a second groove on a surface of a second housing.

Step S210: Dispose a second conducting layer on an inner wall of the second groove.

Step S300: Fasten the first groove and the second groove.

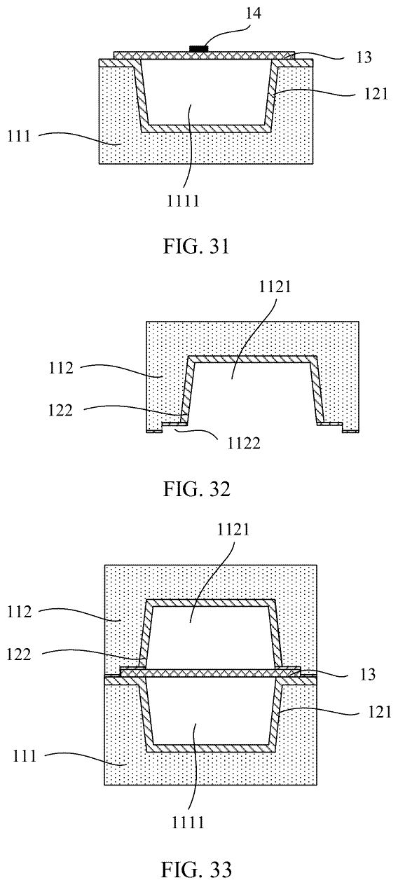

Specifically, refer to FIG. 30 to FIG. 33. When the first housing 111 is prepared, the first housing 111 may use a wafer as an embryo, and prepare the first groove 1111 in the wafer by using a process, for example, an etching process (for example, dry etching or wet etching), to manufacture and form the first housing 111. In the first housing 111 provided in this disclosure, a semiconductor material may be used, processing precision is high, and a nanoscale may be reached, and a preparation process is simple.

Certainly, in another preparation method, the first housing 111 may also be manufactured by using another material. This is not limited in this disclosure.

When the first conducting layer 121 is prepared, a metal material with good conductivity, such as copper or gold, may be formed on the inner wall of the first groove 1111 and the top surface of the first groove 1111 by using a metal deposition process, to prepare the first conducting layer 121. Certainly, in another implementation, the first conducting layer 121 may not be prepared on the top surface of the first groove 1111. Alternatively, a sink structure (not shown in the figure) may be prepared on the top surface of the first groove 1111. In addition, the first conducting layer 121 may also be located on a bottom wall or a side wall of the sink structure.

When the support plate 13 is prepared, the support plate 13 may be manufactured and formed by using a wafer as an embryo, and by using a process, for example, an etching process (for example, dry etching or wet etching). Alternatively, the support plate 13 may be a thin film, and a required shape is manufactured by using a process such as cutting.

When the inner conductor 14 is manufactured, a metal material with good conductivity, such as copper or gold, may be formed on at least one plate surface of the support plate 13 by using a metal deposition process. Certainly, in another preparation method, a formed conductor structure may also be disposed on the support plate 13, and details are not described herein.

When the support plate 13 is fastened to the opening of the first groove 1111, the support plate 13 is fastened to the first housing 111 by using a process, for example, bonding or welding. Certainly, in some implementations, the support plate 13 may also be placed at the opening of the first groove 1111.

When the second housing 112 is prepared, the second housing 112 may use a wafer as an embryo, and prepare the second groove 1121 in the wafer by using a process, for example, an etching process (for example, dry etching or wet etching), to manufacture and form the second housing 112. In the second housing 112 provided in this disclosure, a semiconductor material may be used, processing precision is high, and a nanoscale may be reached, and a preparation process is simple.

Certainly, in another preparation method, the second housing 112 may also be manufactured by using another material. This is not limited in this disclosure.

When the second conducting layer 122 is prepared, a metal material with good conductivity, such as copper or gold, may be formed on the inner wall of the second groove 1121 and the top surface of the second groove 1121 by using a metal deposition process, to prepare the second conducting layer 122. In addition, in an example provided in this disclosure, a second sink 1122 is disposed on the top surface of the second groove 1121, and the second conducting layer 122 is further located on a bottom wall of the second sink 1122. Certainly, in another implementation, the second conducting layer 122 may not be prepared on the top surface of the second groove 1121.

Finally, the first housing 111 and the second housing 112 may be fastened to each other. The first housing 111 may be directly fastened to the second housing 112, or may be and the first housing 111 may be fastened to the second housing 112 by using the support plate 13. For example, when the top surface of the first groove 1111 is in contact with the top surface of the second groove 1121, the top surface of the first groove 1111 may be connected to the top surface of the second groove 1121 by using a bonding or welding process, to fasten the first housing 111 to the second housing 112. Alternatively, when the first conducting layer 121 is in contact with the second conducting layer 122, the first conducting layer 121 and the second conducting layer 122 may be connected by using a bonding or welding process, to fasten the first housing 111 to the second housing 112. Alternatively, the first housing 111 may be fastened to the support plate 13, and the second housing 112 may be fastened to the support plate 13, to fasten the first housing 111 to the second housing 112.

The transmission line provided in embodiments of this disclosure may be manufactured by using a preparation process. This helps improve preparation convenience, and further helps ensure preparation quality. In addition, the transmission line may be a split structure. Therefore, different structures may be manufactured by using different preparation processes. This helps improve manufacturing efficiency and manufacturing precision, and helps ensure signal transmission performance of the transmission line.

Certainly, in actual preparation work, a proper preparation process and procedure may be selected based on an actual requirement to manufacture the transmission line. Details are not described herein.

The foregoing descriptions are only specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A transmission line, comprising:
an outer housing, comprising:
a first housing comprising a first groove, wherein the first groove comprises a first inner wall; and
a second housing fastened to the first housing and comprising a second groove, wherein the first groove and the second groove are enclosed to form a path, and wherein the second groove comprises a second inner wall;
an outer conductor, comprising:
a first conducting layer disposed on the first inner wall; and
a second conducting layer disposed on the second inner wall;
a support plate suspended in the path and comprising:
a plate surface; and
an edge fastened between the first housing and the second housing; and
an inner conductor disposed on the plate surface.

2. The transmission line of claim 1, wherein the support plate is a thin film.

3. The transmission line of claim 1, wherein the first inner wall comprises:
a side wall; and
a bottom wall, wherein an included angle between the side wall and the bottom wall is greater than 90°.

4. The transmission line of claim 1, wherein the second inner wall comprises:
a side wall; and
a bottom wall, wherein an included angle between the side wall and the bottom wall is greater than 90°.

5. The transmission line of claim 1, wherein the first groove further comprises a top surface, and wherein the support plate is attached to the top surface.

6. The transmission line of claim 1, wherein the first groove further comprises a top surface, wherein the first conducting layer is further disposed on the top surface, and wherein the support plate is attached to the first conducting layer.

7. The transmission line of claim 1, wherein the first groove further comprises a top surface, wherein the top surface comprises a first sink, and wherein the support plate is disposed in the first sink.

8. The transmission line of claim 7, wherein the first sink comprises a bottom wall, and wherein the support plate is attached to the bottom wall.

9. The transmission line of claim 7, wherein the first sink comprises a bottom wall, wherein the first conducting layer is further disposed on the bottom wall, and wherein the support plate is attached to the first conducting layer.

10. The transmission line of claim 1, wherein the second groove further comprises a top surface, and wherein the support plate is attached to the top surface.

11. The transmission line of claim 1, wherein the second groove further comprises a top surface, wherein the second conducting layer is further disposed on the top surface, and wherein the support plate is attached to the second conducting layer.

12. The transmission line of claim 1, wherein the second groove further comprises a top surface, wherein the top surface comprises a second sink, and wherein the support plate is disposed in the second sink.

13. The transmission line of claim 12, wherein the second sink comprises a bottom wall, and wherein the support plate is attached to the bottom wall.

14. The transmission line of claim 12, wherein the second sink comprises a bottom wall, wherein the second conducting layer is further located on the bottom wall, and wherein the support plate is attached to the second conducting layer.

15. The transmission line of claim 1, wherein the support plate further comprises:
sides; and
metalized holes penetrating the sides, and
wherein the first conducting layer and the second conducting layer are configured to electrically connect through the metalized holes.

16. The transmission line of claim 1, wherein the transmission line further comprises a functional device disposed between the support plate and the inner conductor and electrically connected to the inner conductor.

17. A transmission cable, comprising:
a first transmission line;
a second transmission line connected to the first transmission line; and
a third transmission line connected to the first transmission line, wherein each of the first transmission line, the second transmission line, and the third transmission line comprises:
an outer housing, comprising:
a first housing comprising a first groove, wherein the first groove comprises a first inner wall; and
a second housing fastened to the first housing and comprising a second groove, wherein the first groove and the second groove are enclosed to form a path, and wherein the second groove comprises a second inner wall;
an outer conductor, comprising:
a first conducting layer disposed on the first inner wall; and
a second conducting layer disposed on the second inner wall;
a support plate suspended in the path and comprising:
a plate surface; and
an edge fastened between the first housing and the second housing; and
an inner conductor disposed on the plate surface.

18. An electronic device, comprising:
a substrate;
a first electrical component disposed on the substrate;
a second electrical component disposed on the substrate; and
a transmission line comprising:
an outer housing, comprising:
a first housing comprising a first groove, wherein the first groove comprises a first inner wall; and
a second housing fastened to the first housing and comprising a second groove, wherein the first groove and the second groove are enclosed to form a path, and wherein the second groove comprises a second inner wall;
an outer conductor, comprising:
a first conducting layer disposed on the first inner wall; and
a second conducting layer disposed on the second inner wall;
a support plate suspended in the path and comprising:
a plate surface; and
an edge fastened between the first housing and the second housing; and
an inner conductor, disposed on at least one plate surface of the support plate.

19. A method, comprising:
preparing a first groove on a first surface of a first housing;
disposing a first conducting layer on a first inner wall of the first groove;
disposing an inner conductor on at least one plate surface of a support plate;
fastening the support plate to an opening of the first groove;
preparing a second groove on a second surface of a second housing;
disposing a second conducting layer on a second inner wall of the second groove; and
fastening the first groove and the second groove together.

20. The method of claim 19, further comprising:
preparing a first sink on a first top surface of the first groove; or
preparing a second sink on a second top surface of the second groove.
